(19) United States
(12) Patent Application Publication
(10) Pub. No.: US 2005/0046953 A1
(43) Pub. Date: Mar. 3, 2005

(54) Virtual display device for a vehicle instrument panel

(75) Inventors: Piermario Repetto, Orbassano (IT); Stefano Bernard, Orbassano (IT); Luca Liotti, Orbassano (IT); Nereo Pallaro, Orbassano (IT)

Correspondence Address: SUGHRUE MION, PLLC, 2100 PENNSYLVANIA AVENUE, N.W., SUITE 800, WASHINGTON, DC, 20037, US

(73) Assignee: C.R.F. SOCIETA CONSORTILE PER AZIONI

(21) Appl. No.: 10/927,242

(22) Filed: Aug. 27, 2004

(30) Foreign Application Priority Data
Aug. 29, 2003 (IT) TO2003A000662

(51) Int. Cl. G02B 27/14; G02B 3/02; G02B 13/18

(52) U.S. Cl. 359/630

(57) ABSTRACT

A display arrangement for a vehicle instrument panel comprises a wearable support structure on which is disposed a transparent screen positioned in front of an eye of an user to permit part of the background to be seen through this screen; a virtual image generator disposed on the support to generate a virtual image and present it to the user's eyes at a predetermined distance and superimposed over the scene visible through the transparent screen; a device for detecting the position and orientation of the user's head; and a processor connected to vehicle control systems to provide the virtual image generator with a video signal containing information to deliver to the user on the basis of system signals provided by the control systems in such a way that the virtual image generator generates virtual visual information superimposed over the background in predetermined regions of the field of view. The visual information is fixedly located in relation to a frame of reference on the basis of a signal provided by the detection device.

The present invention relates in general to a vehicle instrument panel, that is to say a control system arranged on a structure provided with one or more panels carrying adjustment or measurement devices, indicator instruments, display devices and the like able to allow a driver to control the vehicle conditions.

It is known that instrument panels of some current vehicles are provided with processors able to receive signals from devices disposed in the vehicle, and to present the driver with corresponding information in an organic. and unitary manner by means of a display device.

Because of the constraints on space within the interior of a passenger compartment of motor vehicles, such on-board computers are generally disposed in positions to one side of and/or lower than the head of the driver. This arrangement forces the driver temporarily to take his eyes from the road in order to be able to read the information appearing on the display.

This, naturally, can give rise to a dangerous situation which is more likely the heavier and more intense the traffic, and in general when obstructions to be avoided and the variations in the path to be travelled by the vehicle are more frequent.

The object of this invention is to provide an instrument panel, which eliminates or at least reduces the occurrence of dangerous situations resulting from the above-mentioned disadvantages.

This object is achieved according to the invention by a display arrangement for an instrument panel of a motor vehicle having the characteristics defined in the claims.

One preferred, but non-limitative embodiment of the invention will now be described making reference to the attached drawings, in which:

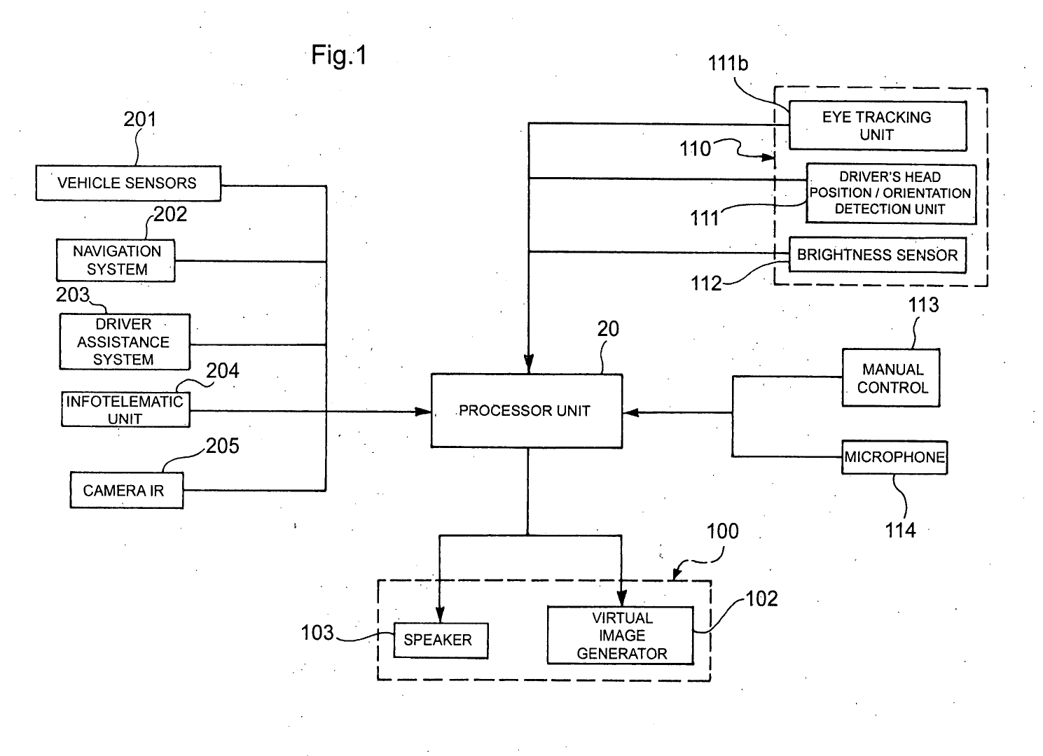

FIG. 1 is a block diagram, which illustrates an embodiment of a vehicle instrument panel provided with the display arrangement according to the present invention;

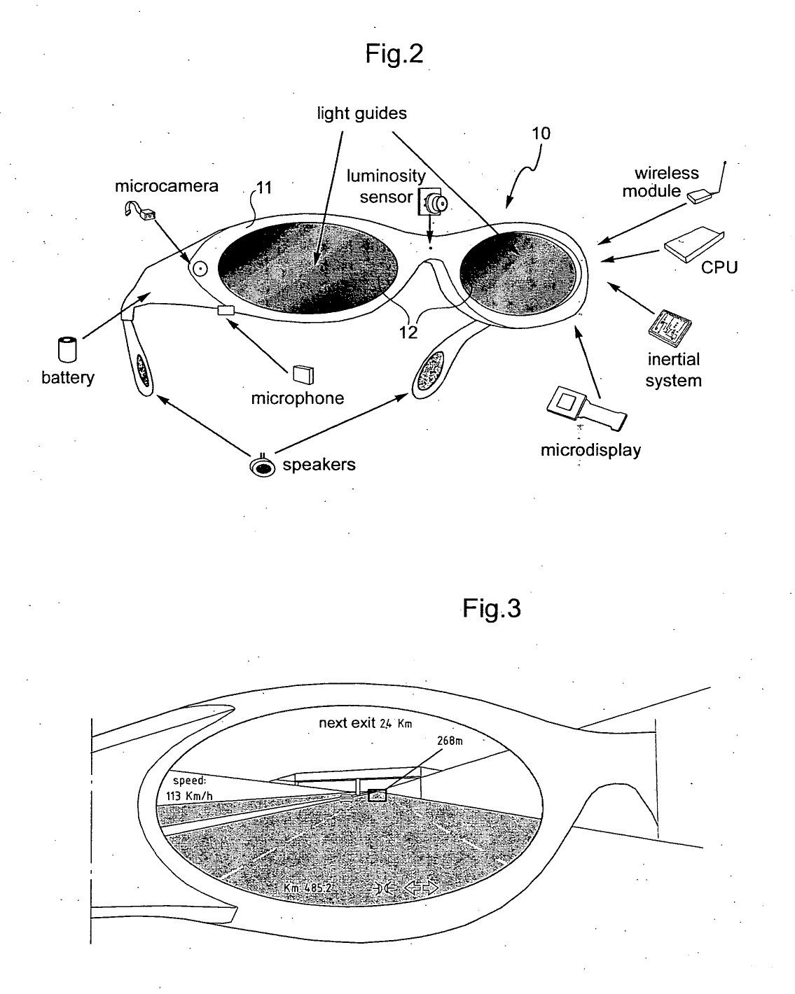

FIG. 2 is a principle scheme, which illustrates the configuration of the panel display arrangement illustrated in FIG. 1; and

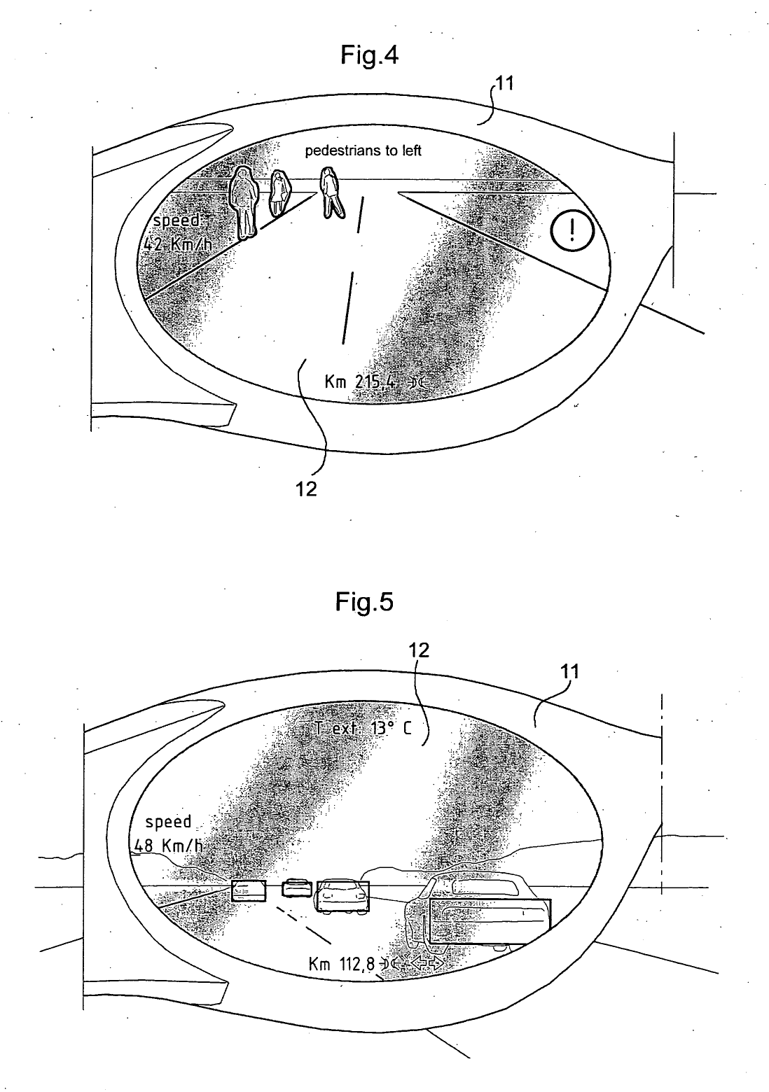

FIGS. 3 to 5 are representations which illustrate examples of use of the display arrangement of the invention.

With reference to FIGS. 1 and 2, a vehicle instrument panel essentially comprises an interface unit 10 (illustrated in FIG. 2) wearable by the driver (not illustrated), and a processor unit 20 to which the said interface unit 10 is operatively connected, able to receive data relating to the vehicle, the journey, or the driving conditions, from various on-board systems (described in more detail hereinbelow) and to process this data and to generate audio-visual information to present to the driver.

The processor unit 20 is preferably integrated on the vehicle on such a way as to reduce to a minimum the computational load of the interface 10; in another preferred embodiment the processor unit can be constituted by two sub-units, one of which is integrated on the vehicle and one integrated on the wearable interface 10, the two being connected together by cable or by “wireless” connection (for example via radio frequency or infrared).

With reference to FIG. 2, the interface unit 10 comprises a support structure 11 which can be worn by the driver, on which is mounted at least one transparent screen element 12 which can be positioned in front of at least one of the driver's eyes (see FIGS. 3 to 5). Preferably, the support structure 11 is formed by a spectacle frame assembly with the transparent screen element 12 being formed by the lenses of these spectacles. This preferred embodiment will always be referred to hereinafter. However, the support structure 11 and the transparent screen element 12 can have another form, for example that of a helmet with an associated visor.

The wearable interface unit 10 includes information rendering means 100, disposed on the support structure 11, for rendering information from the processor unit 20. This information can be of video and/or audio type. These rendering means 100 include a virtual image generator 102 operable to generate a virtual image and to present it to the driver's eyes through the transparent screen 12 at a predetermined distance, the said virtual image being superimposed on the scene visible to the driver through the transparent screen 12. If the distance at which the virtual image is presented is sufficiently large (for example greater than 5 metres) the driver's eye is able to focus on the retina both the background and the virtual image generated by the means 102 with a minimum accommodation. To this end the virtual image generator 102 includes miniaturised image formation means, for example of liquid crystal (LCD), or cathode ray tube (CRT), or organic light emitter device (OLED) type, operable to form a synthetic real image, and an optical system for transformation of the said real image into a virtual image located at a certain distance from the observer and visible to the driver through the transparent screen 12. The transformation of the synthetic image from real to virtual serves to present the video information to the driver at a predetermined distance from the eyes in such a way as to minimise the accommodation of the focal distance. Moreover, the virtual image is presented in such a way that the information of critical importance is displayed in high-resolution regions of the field of view (close to the fovea of the eye) and rapidly accessible. Information which is not critical for safety can be displayed in marginal regions of the field of view, for example at the top (possibly superimposed over the overhead light) or at the bottom (possibly superimposed over the dash board). Preferably, the virtual image is selectively positionable within the field of view of the user by mechanical and/or electronic and/or software means in such a way as to optimise the visibility and usableness of the information presented. The virtual image can be presented to only one or to both eyes, and may or may not contain the same information for both eyes. For example, the field of view subtended by the image presented to the right eye may be only partially superimposed over the field of view subtended by the image presented to the left eye. The information rendering means 100 preferably further include a speaker 103 able to make a sound signal available to the driver.

The wearable interface unit 10 further include sensor means 110, also disposed on the support structure 11, operable to perceive a physical signal from the operator and/or from the surrounding environment, and to make available a corresponding electrical signal representative of this physical signal. The sensor means 110 further include a unit 111 for detection of the position and/or orientation of the driver's head. In a variant of the invention the driver's head position and/or orientation detection unit 111 is constituted by an inertial measurement unit integrated entirely on the wearable interface unit 10; in a further variant of the invention the position/orientation unit 111 includes an inertial measurement unit integrated on the wearable interface unit and a non-inertial measurement unit (for example of the mechanical, magnetic, optical or ultrasonic type) partly integrated on the wearable interface unit 10 and partly integrated on the vehicle.

The visual information can be rendered to the user in a manner related fixedly to the vehicle's frame of reference, similar to what occurs in a traditional instrument panel: this is done for all the information for which a spatial correlation between the virtual image and the environment surrounding the vehicle (or background) over which this virtual image is superimposed is not required. This is the case, for example, with vision-aid systems, for example for improving the night vision (described hereinafter), in which the sensors used are conventionally integrated on the vehicle and therefore fixedly related with it.

If the head position/orientation detection unit 111 is constituted by an inertial measurement unit integrated on the wearable interface unit 10 this unit 111 will provide inertial coordinates, that is to say referred to the frame of reference of the ground (that is the environment surrounding the vehicle); to obtain the inertial coordinates of the user's head with respect to the frame of reference of the vehicle the coordinates with respect to the frame of reference of the ground are corrected by taking into account the inertial coordinates of the vehicle detected by a vehicle navigation system (described hereinafter).

In another variant of the invention, more suitable if the virtual image is not correlated with the environment surrounding the vehicle, but rather with the interior of the vehicle, the head position/orientation detection unit ill comprises a measurement unit of non-inertial type, that is to say one adapted to measure directly the coordinates of the head in the frame of reference of the vehicle. Preferably, this measurement unit comprises a video camera of the optical sensor matrix type, for example CCD or CMOS, integrated on the interface unit 10 in such a position that a plurality of position-locating means are present in the field of view of the video camera. The recognition in real time of the position-locating means makes it possible for the detection unit 111 to identify the position of the user's head with respect of the position-locating means and therefore its coordinates with respect to the vehicle.

To this end the position-locating means are constituted by visual indicator means, for example an LED operating with visible or infrared radiation. Alternatively, such LEDs are integrated on the interface unit 10 and the position-locating means are constituted by simple reflectors which receive the radiation from the LEDs and reflect it towards the video camera integrated on the interface unit 10.

In an alternative configuration the video camera is integrated on the vehicle, whilst the position-locating means are integrated on the interface unit 10.

The data from the head position/orientation detection unit 111 may be neither inertial coordinates nor non-inertial coordinates, but rather raw or only partially conditioned sensor data which are sent to the processor unit 20 and there processed to obtain the coordinates of the head; this is necessary if it is decided to reduce to the minimum the computational power and the memory integrated in the wearable interface unit 10 by delegating the more onerous calculations to non-wearable subunits of the system, that is to say by having them integrated on the vehicle.

Preferably, the sensor means 110 further include an “eye tracking” position unit 111b for measuring the coordinates of the pupil with respect to the frame of reference of the head and therefore the direction in which the driver is looking The data coming from the unit 111b are transmitted to the processor unit 20 in a manner similar to that which takes place for data coming from the unit 111.

As well as the primary function of measuring the position of the pupil, the eye tracking system 111b can be also utilised for monitoring the driver's attention and prevent accidents caused by dropping to sleep. The eye tracking system can also be utilised simultaneously for identification of the driver through retinal recognition.

The sensor means 110 further include an ambient illumination sensor 112 operable to detect the brightness of the environment surrounding the driver, in such a way as to make it possible to adapt the illumination and the colour of the virtual image presented to the driver to that of the real image, thereby optimising the contrast and visibility. In one possible embodiment the function of measuring the brightness, effected by the brightness sensor 112, is achieved via the same optical sensor matrix as is utilised for -the non-inertial measurement unit previously mentioned. The adaptation of the brightness of the virtual image can be obtained by means of screen of variable transmittance capable of varying the transmittance of the optical virtual display system and/or the brightness of the miniaturised means for forming the images in dependence of the ambient luminance in such a way as to optimise the contrast.

In an alternative embodiment the interface unit 10 is formed by two separately wearable sub-units connected to one another by a cable or via “wireless” connection (for example radio frequency or infrared), one of which is integrated on the visor or helmet and the other carried on an article of clothing.

Other interface devices are also provided, disposed on the vehicle's instrument panel, that is to say one or more manually controllable devices 113 of conventional type, and a microphone 114 prearranged to be able to transmit a voice command to the processor unit 20. Preferably, the microphone 114 is also integrated on the support structure 11 of the wearable interface unit 10. These devices make it possible, in a known manner, to select the type of data to be displayed, and possibly their manner of presentation (colour, dimension, position), or to interact with other systems of the vehicle.

Operatively connected to the processor unit 20 are on-board devices and systems of the type normally utilised for the provision to the user of information about the vehicle and its operating conditions. For example, in the case of motor vehicles, such devices and systems include sensor means 201 comprising any type of known sensor which can be installed in modern motor vehicles to detect signals relating to the operating conditions and functionality of the vehicle (for example temperature, pressure and coolant liquid level signals and the like), a trip data processor (or “trip computer”) to process data relating to the fuel consumption, average speed, number of kilometres travelled and the like, a navigation system 202 (equipped, for example,. with vehicle inertial sensors, a GPS receiver and a database of maps), driver assistance systems 203 (for example a “lane warning” system for automatically detecting the position of the vehicle with respect to the edges of the roadway, an “overtake warning” system for controlling the overtaking manoeuvre, an “adaptive cruise control” system for control of the cruising speed and safe distances, a “stop & go” system for control of the speed and safe distances in low speed tail back conditions), a infotelematic unit 204 connected to a network according to the GSM/GPRS or UMTS protocols, and a night vision assistance system for night vision of the road, including an infrared video camera 205. The connection between the processing unit 20 and the above-mentioned on-board devices/systems can be achieved by a cable or by “wireless” connection (for example by a radio frequency or infrared); the “wireless” mode of connection may be unnecessary if at least one subunit of the processor unit 20 is integrated in the wearable interface unit 10.

The processor unit 20 processes the signals from the on-board systems in a conventional manner to provide for generation of video and audio signals containing the information to be delivered to the driver. The data relating to the position of the driver's head with respect to the vehicle and/or the background, and the position of the pupil with respect to the head are utilised by the processor unit 20 to determine, on the basis of the access priority, the distribution of individual elements of information within the driver's field of view. The processor unit 20 therefore transmits the video signal to the virtual image generator 102 in a known manner (via cable or via radio), which latter provides for the associated display to be superimposed on the image viewed directly by the driver and the audio signal at the speakers 103.

In FIGS. 3 to 5 are shown examples of application of the wearable interface unit 10 whilst driving a motor vehicle. In these examples, in which the interface unit 10 is formed as spectacles, the information is displayed in predetermined portions of the driver's field of view defined by the lenses 12 of the spectacles 11. Preferably, the information relating to the function of the vehicle (for example data on speed, engine speed, fuel level, oil temperature, kilometres travelled, turning point indicator etc.) are displayed in peripheral zones of the field of view (for example at the bottom), whilst those relating to the vision assistance (for example for night vision) or to failure indications, imminent dangers or malfunctions are displayed in the central zone of the field of view (corresponding to the path of the vehicle), and those relating to navigation are displayed in the zones of the field of view relating to the rendered navigation information (for example turning point indication, clearance etc.). The peripheral region of the field of view, dedicated to data relating to the function of the vehicle, can also be occlusive type, that is not allowing the background to be seen: this can allow an increase in contrast.

More preferably still, part of the information (for example data on speed, engine speed, fuel level, oil temperature, kilometres travelled, etc.) is presented to the user in a permanent manner as takes place in a current on-board instrument panel, in such a way that the overall effect is that of having a virtual instrument panel superimposed over part of the scene, that is the environment surrounding the vehicle, and in part within the vehicle.

In an advantageous embodiment the overall field of view processed by the system is greater than that which is presented instantaneously to the driver, who can thus displace his head within the overall field of view with movements of the head and/or rotation of the pupil. With respect to the previously-described embodiment, this configuration allows the use of image-formation means of lower resolution in that only a part of the virtual instrument panel is presented at any instant to the driver. Moreover, the optical virtual display system works on a narrower field of view which makes this optical system simpler, lighter and of lower cost. Finally, the driver only sees information presented within a narrow field of view, centred about the direction in which the driver's head is pointing or in which the driver is looking: this is ergonomically advantageous in that the information presented is limited and makes it possible not to distract or confuse the driver.

As will be appreciated, although the display arrangement has been illustrated as a replacement of the traditional on-board instrument panel display devices it can however be utilised as a complement to such on-board instrument panels to present information of assistance to the driver essential for safety.

Naturally, the principle of the invention remaining the same, the details of construction and the embodiments can be widely varied with respect to what has been described and illustrated, without by this departing from the scope of the invention.

1. A display arrangement for a vehicle instrument panel which can be controlled by a vehicle user, wherein it comprises:
a support structure wearable by the user, on which is disposed at least one transparent screen element which can be positioned in front of at least one of the user's eyes in such a way as to permit the user to see at least part of the background through this screen;
virtual image generator means disposed on the said support structure, operable to generate a virtual image variable in time and to present it to the user's eyes through the transparent screen at a predetermined distance, the said virtual image being superimposed on the scene visible by the user through the transparent screen;
means for detecting the position and orientation of the user's head, at least partly disposed on the said support structure; and
a processor unit operatively connected to a plurality of vehicle control systems, operable to provide to the said virtual image generator means a video signal containing information to deliver to the user on the basis of system signals provided by the said plurality of control systems in such a way that the said virtual image generator generates a corresponding virtual visual information superimposed over the background in predetermined regions of the field of view, the said visual information being rendered stationary with respect to a frame of reference predetermined on the basis of a detection signal from the said means for detection of the position and orientation of the user's head.

2. An arrangement according to claim 1, in which the said virtual image generator means comprise miniaturised image formation means operable to form a synthetic real image, and an optical system for transformation of the said real image into a virtual image positioned at a certain distance from the user, the said virtual image being visible to the user through the transparent screen and superimposed on the background.

3. An arrangement according to claim 1, in which the said processor unit is at least partly disposed on the said support structure.

4. An arrangement according to claim 3, in which the said processor unit is in part disposed on the vehicle.

5. An arrangement according to claim 3, in which the said processor unit is in part disposed on an auxiliary support structure separate from the said first support structure and also wearable by the user.

6. An arrangement according to claim 1, in which the said means for detection of the position and orientation of the user's head includes an inertial measurement unit disposed on the said support structure.

7. An arrangement according to claim 1, in which the means for detection of the position and orientation of the user's head include a matrix of optical sensors and a plurality of position-locating reference members respectively disposed on the support structure and on the vehicle, or vice-versa, which cooperate to allow a measurement of the coordinates of the user's head in a reference system of the vehicle.

8. An arrangement according to claim 7, in which the said reference position-locating members are able to emit visible or infrared radiation.

9. An arrangement according to claim 7, in which the said position-locating reference members are able to reflect visible or infrared radiation emitted by visible or infrared radiation emitter means suitably disposed on the wearable interface unit or on the vehicle.

10. An arrangement according to claim 7, in which the said matrix is constituted by a CCD or CMOS video camera.

11. An arrangement according to claim 6, in which the said inertial measurement unit is able to measure the coordinates of the user's head in a frame of reference of the environment surrounding the vehicle.

12. An arrangement according to claim 11, in which the said processor unit is able to compensate the coordinates of the user's head with respect to the frame of reference of the environment surrounding the vehicle with the coordinates of the vehicle with respect to the frame of reference of the environment surrounding the vehicle, the said coordinates of the vehicle being provided by a navigation unit installed on the vehicle to derive the coordinates of the head with respect to the vehicle's frame of reference.

13. An arrangement according to claim 1, in which part of the visual information is displayed fixed in relation to the vehicle's frame of reference and part of the visual information is displayed fixed in relation to the frame of reference of the environment surrounding the vehicle.

14. An arrangement according to claim 13, in which the part of the visual information which is fixed in relation to the frame of reference of the environment surrounding the vehicle relates to navigation information generated in a direct or indirect manner by the navigation unit installed on the vehicle.

15. An arrangement according to claim 1, in which the information of critical importance is displayed in the central region of the field of view around the direction in which the user's head is pointing, and the remaining information is displayed in peripheral regions of this field of view.

16. An arrangement according to claim 1, in which the field of view presented instantaneously to the user is smaller than the overall field of view processed by the central unit so that the user is able to access the information presented outside the instantaneous field of view by rotation of the head, the said rotation being detected by the said position detection means for detecting the position and rotation of the user's head.

17. An arrangement according to claim 1, in which means are provided for tracking the eye operable to measure the coordinates of the user's pupil, that is to say the direction in which the user is looking.

18. An arrangement according to claim 17, in which the information of critical importance is displayed in the region of the field of view close to the said direction in which the user is looking, independently of the direction in which the user's head points, and the remaining information is displayed in the peripheral regions of this field of view.

19. An arrangement according to claim 17, in which the field of view presented instantaneously to the user is smaller than the overall field of view processed by the central unit so that the user is able to access the information present outside the instantaneously presented field of view by rotation of the pupil, the said rotation being detected. by the said eye tracking means.

20. An arrangement according to claim 1, further including means for transmitting and/or receiving sound signals, operable to allow the user to receive audio information from the said processor unit, the said audio information being complementary to the video information generated by the image generation means, and to control and/or configure the said processor unit by voice.

21. An arrangement according to claim 1, further including sensor means for detecting the brightness of the background.

22. An arrangement according to claim 1, in which the said support structure is formed by a spectacle frame, the said transparent screen element being formed by the lenses of such spectacles.

23. An arrangement according to claim 1, in which the said support structure is formed by a helmet, the said transparent screen element being formed by the visor of this helmet.

24. An arrangement according to claim 1, in which the wearable interface unit is battery operated.

25. An arrangement according to claim 1, in which at least some of the connections between the sub-units of the system are formed wireless, via radio frequency or infrared signals.

26. An arrangement according to claim 1, the said arrangement being provided to be installed in motor vehicles, automobiles or boats.

27. An arrangement according to claim 1, the said arrangement being provided as a complement to a traditional on-board instrument panel.

28. An arrangement according to claim 1, the said arrangement being provided in substitution for a traditional on-board instrument panel.

29. An arrangement according to claim 17 in which the said eye tracking means are also provided to monitor the state of attention of the driver for the purposes of preventing accidents.
